(19) United States
(12) Patent Application Publication
(10) Pub. No.: US 2007/0143761 A1
(43) Pub. Date: Jun. 21, 2007

(54) Task scheduler system and method for managing tasks in an embedded system without a real time operating system

(76) Inventor: Yong Deng, Mountain View, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/300,984

(22) Filed: Dec. 15, 2005

(51) Int. Cl. G06F 9/46

(52) U.S. Cl. 718/103

(57) ABSTRACT

A task scheduler system and method for managing tasks in an embedded system executes both unscheduled and scheduled tasks in their respective queues in a prescribed order without dependence on a Real Time Operating System (RTOS).

### BACKGROUND OF THE INVENTION

An embedded system is an application-specific computer system, which is “embedded” in a product, such as a toy, a household appliance, a network equipment, a measurement equipment, a computer printer or an automotive controller. The embedded system is designed to monitor, control and/or perform specific functions associated with the product. These specific functions are often time sensitive, and thus, require a sophisticated task scheduler. A task scheduler for an embedded system manages different tasks to be performed, some of which may be time critical.

Conventional task schedulers for embedded systems run on a Real Time Operating System (RTOS). These conventional task schedulers operate well for their intended purposes. However, there are a number of concerns with the conventional task schedulers, especially for the small/low-cost embedded systems. One of the concerns is that a RTOS on which a conventional task scheduler runs requires a significant amount of storage memory and random access memory. However, there are numerous embedded systems with limited memory spaces, e.g., 0.2-1.5 K bytes of random access memory, and 3-32 K bytes of flash memory. In these embedded systems, the conventional task schedulers cannot be used since there is insufficient memory for the RTOS. Furthermore, some low cost embedded systems include microcontrollers that are not fast enough to overcome the overhead produced by the RTOS. The obvious solution to these problems is to use faster microcontrollers with larger memory. However, in many low cost products, it is cost prohibitive to replace the slower microcontrollers having limited memory with faster microcontrollers having larger memory. Finally, many small embedded devices require very small microcontrollers due to their space limitations. These small microcontrollers do not have sufficient space to have the large amount of memory that the RTOS requires.

Another concern with the conventional task schedulers is that the required RTOS may have a license fee associated with it. For low cost products, the payment of RTOS license fee for every single product may not be possible with the established cost structure. This is compounded by the cost associated with using larger microcontrollers having large memory.

In view of these concerns, what is needed is a task scheduler system and method for managing tasks in an embedded system, which can be executed using low cost microcontrollers having limited memory, e.g., 0.2-1.5 K bytes of random access memory and 3-32 K bytes of flash memory.

### SUMMARY OF THE INVENTION

A task scheduler system and method for managing tasks in an embedded system executes both unscheduled and scheduled tasks in their respective queues in a prescribed order without dependence on a Real Time Operating System (RTOS). Thus, the task scheduler system does not require a RTOS to be present or installed in an embedded system. Consequently, the task scheduler system can be used in an embedded system with very limited memory space, for example, an embedded system that uses a low cost microcontroller.

A method for managing tasks in an embedded system in accordance with an embodiment of the invention comprises executing enabled unscheduled high priority tasks, executing scheduled high priority tasks while yielding execution priority of the scheduled high priority tasks to the enabled unscheduled high priority tasks, and executing scheduled low priority tasks while yielding execution priority of the scheduled low priority tasks to the enabled unscheduled high priority tasks and the scheduled high priority tasks, wherein the executing of enabled unscheduled high priority tasks, the executing of scheduled high priority tasks and the executing of scheduled low priority tasks are performed without a RTOS in the embedded system.

A task scheduler system for managing tasks in an embedded system in accordance with an embodiment of the invention comprises an unscheduled high priority task queue containing unscheduled high priority tasks, a scheduled high priority task queue containing scheduled high priority tasks, a scheduled low priority task queue containing scheduled low priority tasks, and a task scheduler operatively connected to the unscheduled and scheduled task queues. The task scheduler is configured to execute enabled unscheduled high priority tasks, to execute the scheduled high priority tasks while yielding execution priority of the scheduled high priority tasks to the enabled unscheduled high priority tasks, and to execute the scheduled low priority tasks while yielding execution priority of the scheduled low priority tasks to the enabled unscheduled high priority tasks and the scheduled high priority tasks. The task scheduler is further configured to perform execution of tasks without dependence on a Real Time Operating System in the embedded system.

An embedded system in accordance with an embodiment of the invention comprises memory containing a task scheduler computer program and a processing unit configured to run the task scheduler computer program without a Real Time Operating System so that the task scheduler computer program performs method steps for managing tasks. The method steps comprise executing enabled unscheduled high priority tasks, executing scheduled high priority tasks while yielding execution priority of the scheduled high priority tasks to the enabled unscheduled high priority tasks, and executing scheduled low priority tasks while yielding execution priority of the scheduled low priority tasks to the enabled unscheduled high priority tasks and the scheduled high priority tasks.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of an embedded system without a Real Time Operating System (RTOS) in accordance an embodiment of the invention.

FIG. 2 is a functional block diagram of a RTOS-less task scheduler system in accordance with an embodiment of the invention.

FIG. 3 is an activity diagram of the operation of the task scheduler system of FIG. 2 in accordance with an embodiment of the invention.

FIG. 4 is a flow diagram of a method for managing tasks in an embedded system in accordance with an embodiment of the invention.

### DETAILED DESCRIPTION

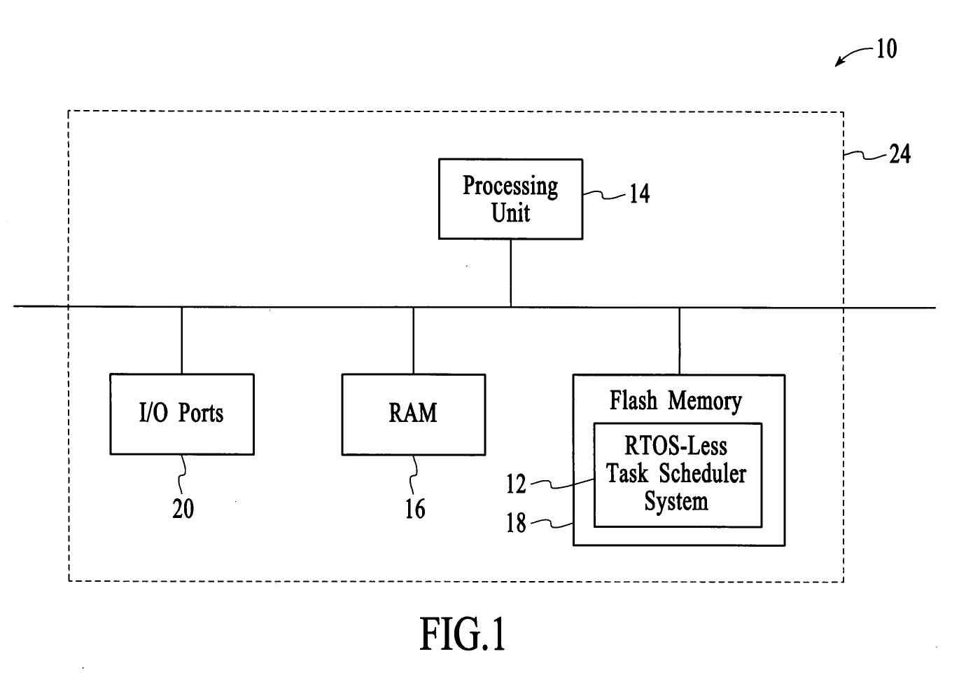

With reference to FIG. 1, an embedded system 10 without a Real Time Operating System (RTOS) in accordance with an embodiment of the invention is described. FIG. 1 is a block diagram of the embedded system 10. The embedded system 10 may be included in any product that requires a computer system to perform different tasks associated with the operation of the product. As an example, the embedded system 10 may be included in household appliances, toys, telephones, network components and electronic automotive components. As described in more detail below, the embedded system 10 includes a RTOS-less task scheduler system 12, which does not require to run on a RTOS as conventional task scheduler systems. Thus, the RTOS-less task scheduler system 12 is not dependent on a RTOS.

As shown in FIG. 1, the embedded system 10 includes a processing unit 14, a random access memory (RAM) 16, a flash memory 18, and input/output ports 20. The processing unit 14 is a central processing unit that runs the RTOS-less task scheduler system 12, which is a computer program stored in the flash memory 18. The flash memory 18 may also store other computer programs to be used by the processing unit 14. The processing unit 14 may also perform other operations. The RAM 16 is used by the processing unit 14 to store data for various operations, including running the RTOS-less task scheduler system 12. The embedded system 10 includes other components commonly found in embedded systems, which are not shown and described herein so that the inventive features of the embedded system are not obscured. In some embodiments, most of the components of the embedded system 10 may be incorporated in a microcontroller 24. In other embodiments, most of the components of the embedded system 10 may be incorporated in a system-on-chip.

In an embodiment, the flash memory 18 may have a storage capacity of 4-32 k bytes, which is common in low cost microcontrollers. Consequently, in this embodiment, the flash memory 18 cannot be used to store a typical RTOS program. Thus, a conventional task scheduler system cannot be used by the embedded system 10 since such a task scheduler system is part of a RTOS. However, the RTOS-less task scheduler system 12 in accordance with an embodiment of the invention requires less than one thousand (1000) bytes of memory space. For example, the RTOS-less task scheduler system 12 requires less than seven hundred (700) bytes of memory space, or six hundred twenty (620) bytes to be exact, when running on a PIC18F452 microcontroller. Thus, the RTOS-less task scheduler system 12 can be installed in typical low cost microcontrollers, such as the PIC18F452 microcontrollers.

The RTOS-less task scheduler system 12, when executed by the processing unit 14, operates to manage tasks to be performed by various components of the product in which the embedded system 10 is contained. The tasks include scheduled tasks and unscheduled tasks. These scheduled and unscheduled tasks are dependent on the product containing the embedded system 10. The scheduled tasks include tasks that have been prescheduled to be performed in certain sequence. Examples of scheduled tasks, if the product containing the embedded system 10 is an optical transceiver, include bias current monitoring, transmitter power monitoring, module temperature monitoring and receiver power monitoring. The unscheduled tasks include tasks that have not been prescheduled to be performed. Examples of unscheduled tasks, if the product containing the embedded system 10 is an optical transceiver, include setting laser bias and setting laser modulation. In an embodiment, the scheduled tasks are divided into two classes, high priority and low priority. Similarly, the unscheduled tasks are divided into two classes, high priority and low priority. However, in other embodiments, the scheduled and unscheduled tasks may be divided into any number of classes.

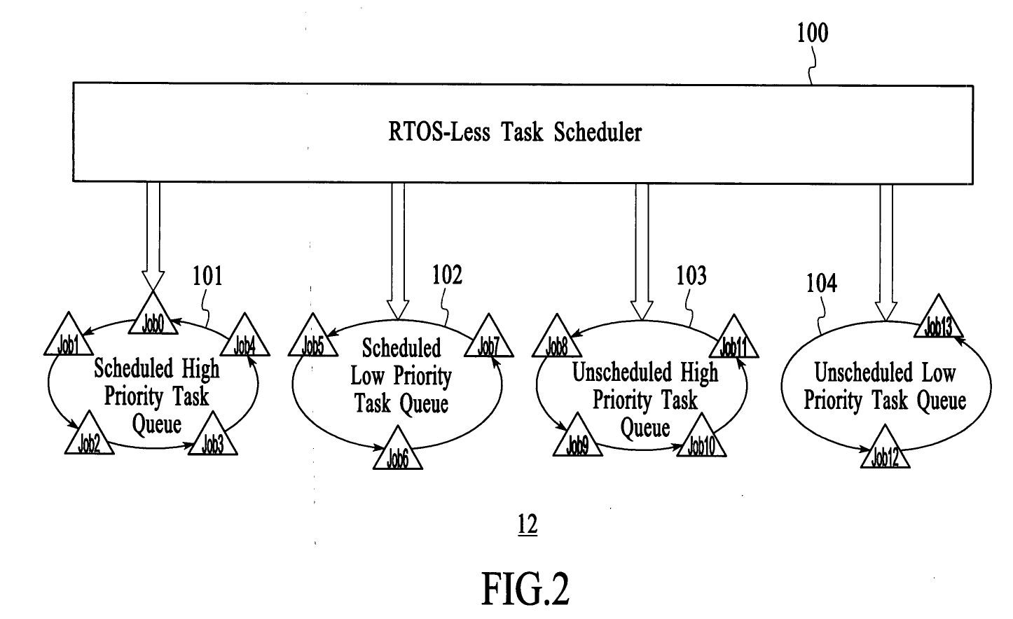

Turning now to FIG. 2, a functional block diagram of the RTOS-less task scheduler system 12 is shown. As shown in FIG. 2, the RTOS-less task scheduler system 12 includes a RTOS-less task scheduler 100 and four task queues 101, 102, 103, and 104. The task scheduler 100 schedules and manages the tasks to be executed in the task queues 101, 102, 103, and 104 in a prescribed manner, as described in detail below. The queue 101 is a scheduled high priority task queue, which contains one or more scheduled high priority tasks/jobs, for example, Job0, Job1, Job2, Job3 and Job4. The queue 102 is a scheduled low priority task queue, which contains one or more scheduled low priority tasks/jobs, for example, Job5, Job6 and Job7. The queue 103 is an unscheduled high priority task queue, which contains one or more unscheduled high priority tasks/jobs, for example, Job8, Job9, Job10 and Job11. The queue 104 is an unscheduled low priority task queue, which contains one or more unscheduled low priority tasks/jobs, for example, Job12 and Job13. Each of the queues 101, 102, 103 and 104 is defined as a set of linked pointers, where each linked pointer points to the entry memory address of a function which represents a task/job in the queue. Thus, the process of executing a task in one of the task queues 101, 102, 103 and 104 involves jumping to the entry of a memory address where a particular task/job is located. The various components of the embedded system 10 that submitted tasks in the queues 101, 102, 103 and 104 never actively launch these tasks by themselves. These tasks are “call-backed” by the task scheduler 100 instead. It is the task scheduler 100 that determines when and how often to run the tasks in each of the queues 101, 102, 103 and 104.

Both the scheduled high priority task queue 101 and the scheduled low priority task queue 102 are defined as circular queues. All the tasks/jobs in the scheduled task queues 101 and 102 are scheduled to run continually in a circular manner. However, all the tasks in the scheduled high priority task queue 101 have higher execution priorities than the tasks in the scheduled low priority task queue 102. The priority is arranged in such a way that one complete run in the scheduled high priority task queue 101 will result in only one single job execution in the scheduled low priority task queue 102. Hence, each task in the scheduled low priority task queue 102 gets less chance to run than the tasks in the scheduled high priority task queue 101. For example, in FIG. 2, Job5 in the scheduled low priority task queue 102 won't get a chance to run until Job0-Job4 in the scheduled high priority task queue 101 have completed their executions. In addition, Job6 in the scheduled low priority task queue 102 cannot be launched immediately after the completion of Job5. Instead, Job6 has to wait until Job0-Job4 in the scheduled high priority task queue 101 have completed another round of executions. This sequence will be repeated continually unless there are unscheduled tasks that need to be serviced, which will be described later.

The unscheduled high and low priority task queues 103 and 104 also contain respective tasks that are executed in a circular manner similar as the tasks in the scheduled high and low priority task queues 101 and 102, as described earlier. However, in the unscheduled task queues 103 and 104, only those tasks that are enabled will be performed. In the task scheduler system 12, a task is “enabled” in the unscheduled queues 103 and 104 only if the execution flag associated with that task is turned on. As an example, in FIG. 2, the unscheduled high priority task queue 103 contains four tasks in the following order: Job8, Job9, Job10 and Job11. In this example, Job9 and Job11 are currently enabled, as indicated by the use of bold font in FIG. 2, while Job8 and Job10 are currently disabled, as indicated by the use of regular font. Thus, in this example, the enabled Job9 will be performed first and then the enabled Job11 will be performed, skipping the disabled Job8 and Job10. In general, these execution flags, which are the indication of “enabled tasks”, will be turned off after the enabled tasks are executed to mark the completion of the enabled tasks.

The number of tasks/jobs in each of the queues 101, 102, 103 and 104 in FIG. 2 is merely an example. The task scheduler system 12 is designed to be capable of including additional tasks in the queues 101, 102, 103 and 104 as long as the system storage space permits.

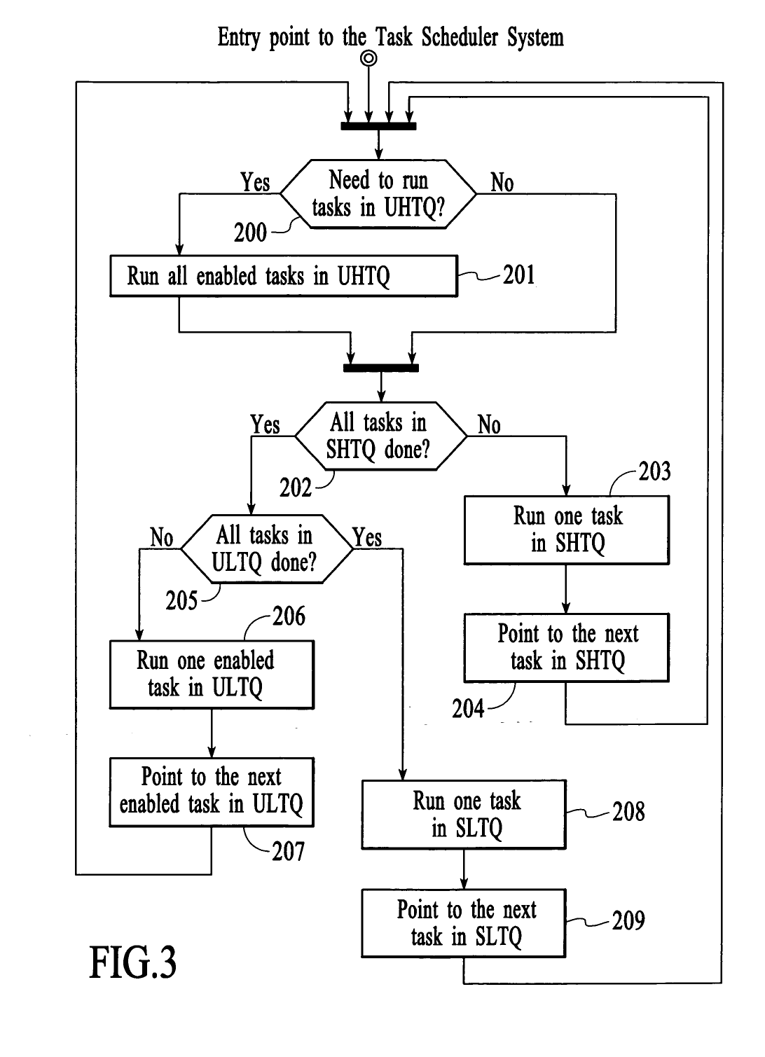

An overall operation of the RTOS-less task scheduler system 12 in accordance with an embodiment of the invention is now described with reference to a process activity diagram of FIG. 3, as well as to the block diagram of FIG. 2. At block 200, a determination is made whether there are any unscheduled high priority tasks in the unscheduled high priority task queue (UHTQ) 103 that need to be served immediately. If the answer is yes, then at block 201, all the tasks with the execution flags ON in the UHTQ 103 will be executed once. The operation then proceeds to block 202. On the other hand, if the answer at block 200 is no, then the operation proceeds directly to block 202.

At block 202, a determination is made whether all the tasks in the scheduled high priority task queue (SHTQ) 101 have been executed once. If the answer is no, then the first unexecuted task in the SHTQ 101 is executed, at block 203. Next, the SHTQ 101 will move its pointer to the next task in the SHTQ that needs to be executed, at block 204. The operation then proceeds back to block 200 to check if there are any unscheduled high priority tasks that need to be immediately served. Thus, the execution of scheduled high priority tasks is performed while yielding the execution priority of the scheduled high priority tasks to the enabled unscheduled high priority tasks. On the other hand, if the answer for block 202 is yes, then the operation proceeds to block 205.

At block 205, a determination is made whether all the enabled tasks in the unscheduled low priority task queue (ULTQ) 104 have been run once. If the answer is no, then the first unexecuted enabled task in the ULTQ 104 is executed, at block 206. Same as the tasks in UHTQ 103, the execution flag associated with this task normally will be turned off after all the enabled tasks in the ULTQ 104 have been executed. Next, the ULTQ 104 will move its pointer to the next enabled task in the ULTQ that needs to be executed, at block 207. The operation then proceeds back to block 200 to check if there are any unscheduled high priority tasks that need to be immediately served. Thus, the execution of enabled unscheduled low priority tasks is performed while yielding the execution priority of the enabled unscheduled low priority tasks to the enabled unscheduled high priority tasks and the scheduled high priority tasks. On the other hand, if the answer for block 205 is yes, then the operation proceeds to block 208, where the first unexecuted task in the scheduled low priority task queue (SLTQ) 104 is executed. Next, the SLTQ 104 will move its pointer to the next task in the SLTQ that needs to be executed, at block 209. The operation then proceeds back to block 200 to check if there are any unscheduled high priority tasks that need to be immediately served. Thus, the execution of scheduled low priority tasks is performed while yielding the execution priority of the scheduled low priority tasks to the enabled unscheduled high priority tasks, the scheduled high priority tasks and the enabled unscheduled low priority tasks.

After the unscheduled tasks in both UHTQ 103 and ULTQ 104 have been executed, their associated execution flags will be cleared. However, the scheduled tasks in both SHTQ 101 and SLTQ 102 will continue to be executed, until some event triggers the execution flag of one or more tasks in either UHTQ 103 or ULTQ 104. These enabled unscheduled tasks will then be served in the manner as described above.

The RTOS-less task scheduler system 12 defines the priorities for its task queues 101, 102, 103 and 104 in the following orders: UHTQ 103, SHTQ 101, ULTQ 104, and SLTQ 102, where tasks in the UHTQ have the highest priority, and the tasks in the SLTQ have the lowest priority. Although the RTOS-less task scheduler system 12 has been described as managing four types of tasks, i.e., the scheduled high and low priority tasks and the unscheduled high and low priority tasks, in other embodiments, the RTOS-less task scheduler system can manage fewer or additional types of tasks.

In an embodiment, the RTOS-less task scheduler system 12 is written in American National Standard for Information System (ANSI) C language, which is one of the most common languages used in low cost small embedded systems. Furthermore, the RTOS-less task scheduler system 12 is written to be independent of hardware/microcontroller. Thus, it is portable and can be used in any low cost embedded system that cannot or do not use a RTOS. The RTOS-less task scheduler system 12 is significantly smaller in size than a RTOS program, and thus, can be used in low cost embedded systems with very limited memory space. However, unlike conventional task scheduler systems that run on a RTOS, the task scheduler system 12 is much more efficient since it does not have any operational overhead.

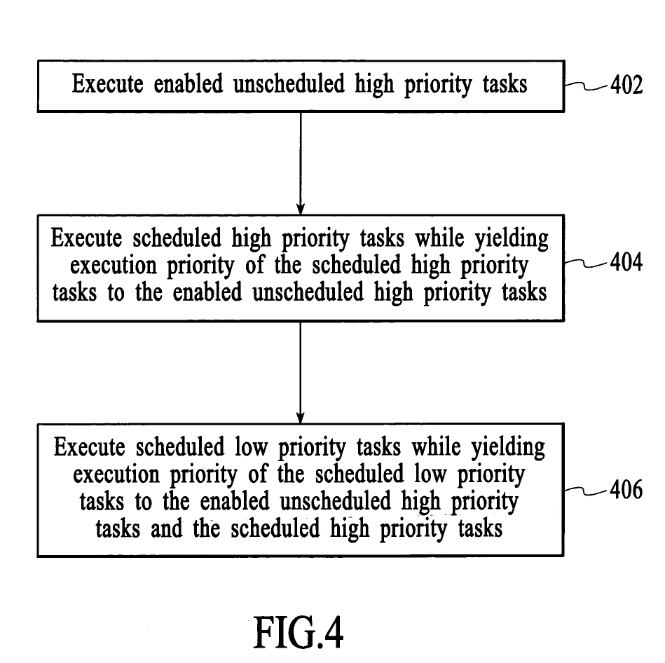

A method for managing tasks in an embedded system without a RTOS in accordance with an embodiment of the invention is described with reference to a flow diagram of FIG. 4. At block 402, enabled unscheduled high priority tasks are executed. Next, at block 404, scheduled high priority tasks are executed while yielding execution priority of the scheduled high priority tasks to the enabled unscheduled high priority tasks. Next, at block 406, scheduled low priority tasks are executed while yielding execution priority of the scheduled low priority tasks to the enabled unscheduled high priority tasks and the scheduled high priority tasks. The executing of enabled unscheduled high priority tasks, the executing of scheduled high priority tasks and the executing of scheduled low priority tasks are performed without a Real Time Operating System in the embedded system.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for managing tasks in an embedded system, the method comprising:
executing enabled unscheduled high priority tasks;
executing scheduled high priority tasks while yielding execution priority of the scheduled high priority tasks to the enabled unscheduled high priority tasks; and
executing scheduled low priority tasks while yielding execution priority of the scheduled low priority tasks to the enabled unscheduled high priority tasks and the scheduled high priority tasks,
wherein the executing of enabled unscheduled high priority tasks, the executing of scheduled high priority tasks and the executing of scheduled low priority tasks are performed without a Real Time Operating System in the embedded system.

2. The method of claim 1 wherein the executing of scheduled high priority tasks includes repeating the executing of enabled unscheduled high priority tasks after each scheduled high priority task is executed.

3. The method of claim 1 wherein the executing of scheduled low priority tasks includes repeating the executing of enabled unscheduled high priority tasks and the executing of scheduled high priority tasks after each scheduled low priority task is executed.

4. The method of claim 1 further comprising executing enabled unscheduled low priority tasks while yielding execution priority of the enabled unscheduled low priority tasks to the enabled unscheduled high priority tasks and to the scheduled high priority tasks.

5. The method of claim 4 wherein the executing of enabled unscheduled low priority tasks includes repeating the executing of enabled unscheduled high priority tasks and the executing of scheduled high priority tasks after each enabled unscheduled low priority task is executed.

6. The method of claim 1 wherein each of the executing of enabled unscheduled high priority tasks, the executing of scheduled high priority tasks and the executing of scheduled low priority tasks includes using a set of pointers to execute a particular task wherein each pointer points to a memory address of the particular task.

7. The method of claim 1 wherein the executing of enabled unscheduled high priority tasks, the executing of scheduled high priority tasks and the executing of scheduled low priority tasks are performed by a processing unit running a task scheduler computer program stored in memory of the embedded system, the task scheduler computer program requiring less than one thousand bytes of memory space in the embedded system.

8. The method of claim 7 wherein the task scheduler computer program requires less than seven hundred bytes of memory space in the embedded system.

9. A task scheduler system for managing tasks in an embedded system, the task scheduler system comprising:
an unscheduled high priority task queue containing unscheduled high priority tasks;
a scheduled high priority task queue containing scheduled high priority tasks;
a scheduled low priority task queue containing scheduled low priority tasks; and
a task scheduler operatively connected to the unscheduled and scheduled task queues, the task scheduler being configured to execute enabled unscheduled high priority tasks, to execute the scheduled high priority tasks while yielding execution priority of the scheduled high priority tasks to the enabled unscheduled high priority tasks, and to execute the scheduled low priority tasks while yielding execution priority of the scheduled low priority tasks to the enabled unscheduled high priority tasks and the scheduled high priority tasks, the task scheduler being further configured to perform execution of tasks without dependence on a Real Time Operating System in the embedded system.

10. The task scheduler system of claim 9 wherein the unscheduled high priority tasks, the scheduled high priority tasks and the scheduled low priority tasks are sets of pointers in the respective queues wherein each pointer points to a memory address of a particular task.

11. The task scheduler system of claim 9 wherein the task scheduler is configured to repeat execution of enabled unscheduled high priority tasks after each scheduled high priority task is executed.

12. The task scheduler system of claim 9 wherein the task scheduler is configured to repeat execution of enabled unscheduled high priority tasks and scheduled high priority tasks after each scheduled low priority task is executed.

13. The task scheduler system of claim 9 further comprising an unscheduled low priority task queue containing unscheduled low priority tasks, and wherein the task scheduler is further configured to execute enabled unscheduled low priority tasks while yielding execution priority of the enabled unscheduled low priority tasks to the enabled unscheduled high priority tasks and to the scheduled high priority tasks.

14. The task scheduler system of claim 13 wherein the task scheduler is configured to repeat execution of enabled unscheduled high priority tasks and the scheduled high priority tasks after each enabled unscheduled low priority task is executed.

15. The task scheduler system of claim 9 wherein the task scheduler requires less than one thousand bytes of memory space in the embedded system.

16. An embedded system comprising:
memory containing a task scheduler computer program; and
processing unit configured to run the task scheduler computer program without a Real Time Operating System so that the task scheduler computer program performs method steps for managing tasks, the method steps comprising:
executing enabled unscheduled high priority tasks;
executing scheduled high priority tasks while yielding execution priority of the scheduled high priority tasks to the enabled unscheduled high priority tasks; and
executing scheduled low priority tasks while yielding execution priority of the scheduled low priority tasks to the enabled unscheduled high priority tasks and the scheduled high priority tasks.

17. The embedded system of claim 16 wherein the executing of scheduled high priority tasks includes repeating the executing of enabled unscheduled high priority tasks after each scheduled high priority task is executed.

18. The embedded system of claim 16 wherein the method steps further comprises executing enabled unscheduled low priority tasks while yielding execution priority of the enabled unscheduled low priority tasks to the enabled unscheduled high priority tasks and to the scheduled high priority tasks.

19. The embedded system of claim 16 wherein each of the executing of enabled unscheduled high priority tasks, executing of scheduled high priority tasks and executing of scheduled low priority tasks includes using a set of pointers to execute a particular task wherein each pointer points to a memory address of the particular task.

20. The embedded system of claim 16 wherein the task scheduler computer program requires less than one thousand bytes of memory space in the embedded system.
